(19) United States
(12) Patent Application Publication
(10) Pub. No.: US 2014/0094158 A1
(43) Pub. Date: Apr. 3, 2014

(54) TERMINAL APPARATUS AND METHOD FOR CHANGING SETTING THEREOF

(71) Applicant: FUJITSU LIMITED, Kawasaki-shi (JP)

(72) Inventor: Yoshifumi MAEDA, Kawasaki (JP)

(73) Assignee: FUJITSU LIMITED, Kawasaki-shi (JP)

(21) Appl. No.: 13/974,683

(22) Filed: Aug. 23, 2013

(30) Foreign Application Priority Data
Oct. 2, 2012 (JP) 2012-220544

(51) Int. Cl. H04W 8/22

(52) U.S. Cl. CPC H04W 8/22
USPC 455/418

(57) ABSTRACT

A terminal apparatus includes a memory and a processor. The memory stores group information in association with identification information for identifying respective nearby apparatuses within a certain range from the terminal apparatus. The group information indicates first groups to which the respective nearby apparatuses belong. The processor receives first identification information of respective first nearby apparatuses in a certain period of time. The processor identifies, based on the group information, second groups to which the first nearby apparatuses identified by respective pieces of the received first identification information belong. The processor determines a setting description for the terminal apparatus in accordance with the identified second groups. The processor changes setting of the terminal apparatus in accordance with the determined setting description.

### CROSS-REFERENCE TO RELATED APPLICATION

This application is based upon and claims the benefit of priority of the prior Japanese Patent Application No. 2012-220544, filed on Oct. 2, 2012, the entire contents of which are incorporated herein by reference.

### FIELD

The embodiments discussed herein are related to a terminal apparatus and a method for changing setting thereof.

### BACKGROUND

Some of today's terminal apparatuses, such as mobile phones, have functions of manner mode (silent mode with vibration), Privacy Mode (registered trademark) and so on. The users of the terminal apparatuses have to set or release the manner mode, privacy mode, or the like by themselves, as appropriate. Thus, the users might sometimes forget to release the manner mode, privacy mode, or the like, leaving the mode turned on. There is a technology for automatically switching the mode of a terminal apparatus to the manner mode or privacy mode in accordance with its position information acquired utilizing a global positioning system (GPS).

In connection with the technology, a mobile terminal apparatus has been available which automatically sets its mode to a manner mode in accordance with the presence/absence of people in the vicinity of the terminal apparatus, without installation of a large-scale apparatus.

Another mobile terminal apparatus has also been available by which white card information including simple personal information is exchanged between mobile phones via a near-distance wireless communication unit. Pieces of white card information received in a predetermined period of time are automatically grouped and the grouped white card information is displayed on a display unit.

Japanese Laid-open Patent Publication No. 2007-135009 and Japanese Laid-open Patent Publication No. 2009-147828 disclose related techniques.

When a GPS is utilized as described above, there are cases in which, depending on the accuracy of the position information acquired utilizing the GPS, a problem may arise with the mode switching. There is also a problem in which no GPS may be usable indoors.

### SUMMARY

According to an aspect of the present invention, provided is a terminal apparatus including a memory and a processor. The memory stores group information in association with identification information for identifying respective nearby apparatuses within a certain range from the terminal apparatus. The group information indicates first groups to which the respective nearby apparatuses belong. The processor receives first identification information of respective first nearby apparatuses in a certain period of time. The processor identifies, based on the group information, second groups to which the first nearby apparatuses identified by respective pieces of the received first identification information belong. The processor determines a setting description for the terminal apparatus in accordance with the identified second groups. The processor changes setting of the terminal apparatus in accordance with the determined setting description.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a hardware configuration of a terminal apparatus;

FIG. 2 is a diagram illustrating an example of a functional configuration of an application unit;

FIG. 3 is a diagram illustrating an example of a telephone directory;

FIG. 4 is a sequence chart illustrating an example of processing of a terminal apparatus;

FIG. 5 is a flowchart illustrating an example of processing performed by a mode determination unit;

FIG. 6 is a diagram illustrating an example of a functional configuration of an application unit;

FIG. 7 is a diagram illustrating an example of a telephone directory;

FIG. 8 is a diagram illustrating an example of a setting condition table;

FIG. 9 is a sequence chart illustrating an example of processing performed by a terminal apparatus;

FIG. 10 is a flowchart illustrating an example of processing performed by a setting-description determination unit;

FIG. 11 is a diagram illustrating an example of a setting screen for a setting condition table;

FIG. 12 is a diagram illustrating an example of a MAC address list;

FIG. 13 is a diagram illustrating an example of a group list; and

FIG. 14 illustrates an example of a case in which time slots are added to a setting condition table.

### DESCRIPTION OF EMBODIMENTS

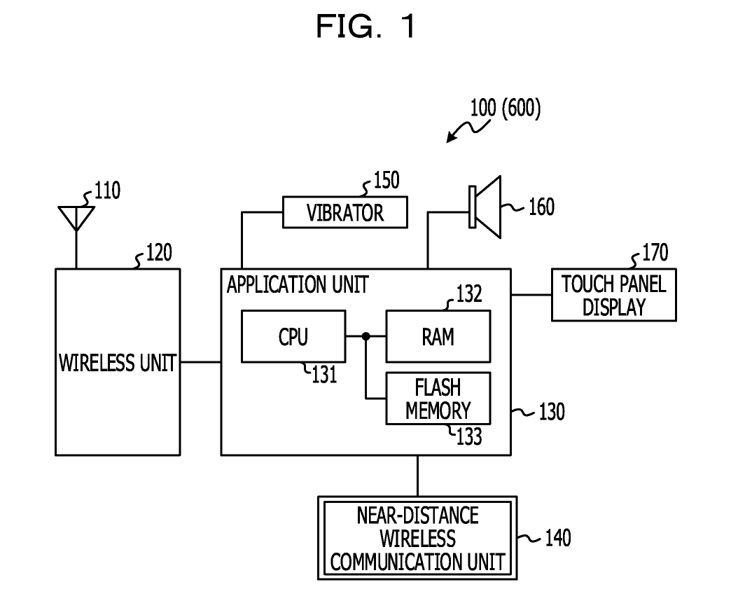

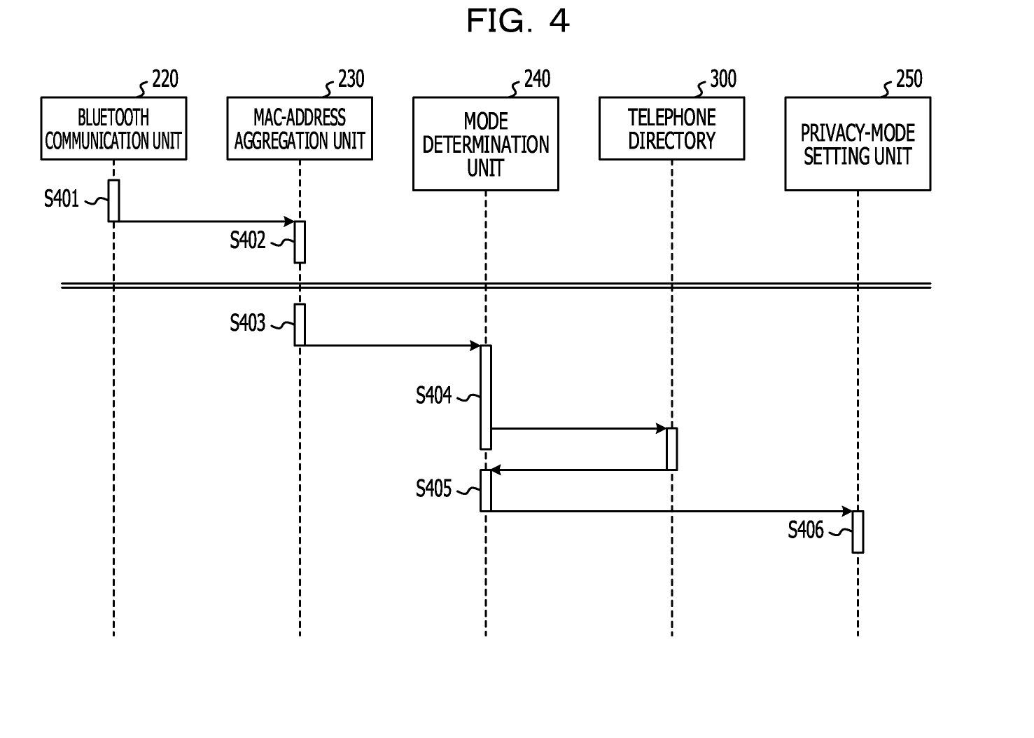

Embodiments will be described below with reference to FIGS. 1 to 14. The embodiments described below are merely exemplary and illustrative, and are not intended to exclude application of various modifications and technologies not explicitly described hereinafter. That is, the embodiments herein may be practiced in various forms, for example, through combination of the embodiments, without departing from the spirit and scope of the embodiments. The procedures illustrated in FIGS. 4, 5, 9 and 10 are not aimed to restrict the processing sequences. Therefore, it goes without saying that processing sequences may be interchanged, if possible.

### First Embodiment

FIG. 1 is a diagram illustrating an example of a hardware configuration of a terminal apparatus 100 according to a first embodiment.

The terminal apparatus 100 includes an antenna 110, a wireless unit 120, an application unit 130, a near-distance wireless communication unit 140, a vibrator 150, a speaker 160, and a touch panel display 170. The terminal apparatus 100 may be a mobile phone.

The wireless unit 120 performs wireless communication using a telephone network or the like to transmit data to and receive data from another terminal apparatus. For example, the wireless unit 120 transmits data, sent from the application unit 130, to another communication terminal, and sends, upon receiving data transmitted from another terminal apparatus, the received data to the application unit 130. The wireless unit 120 is also capable of establishing a communication link with another terminal apparatus through a telephone network.

The application unit 130 includes a central processing unit (CPU) 131, a random access memory (RAM) 132, and a flash memory 133.

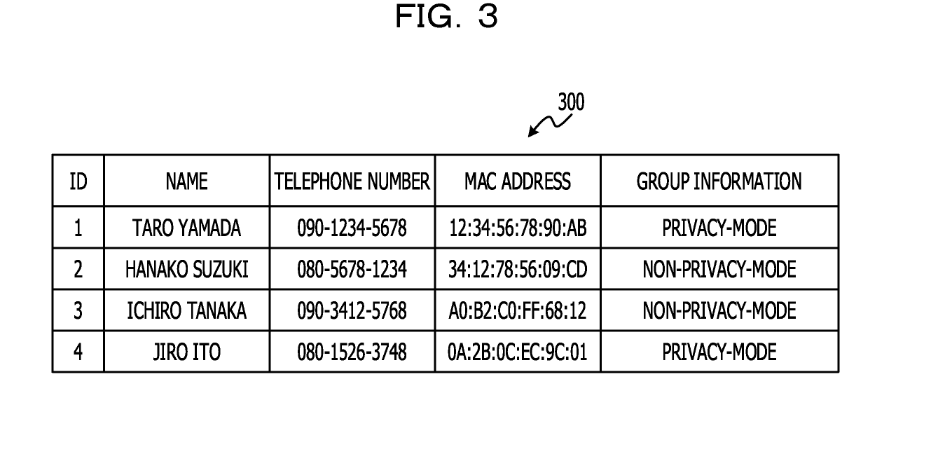

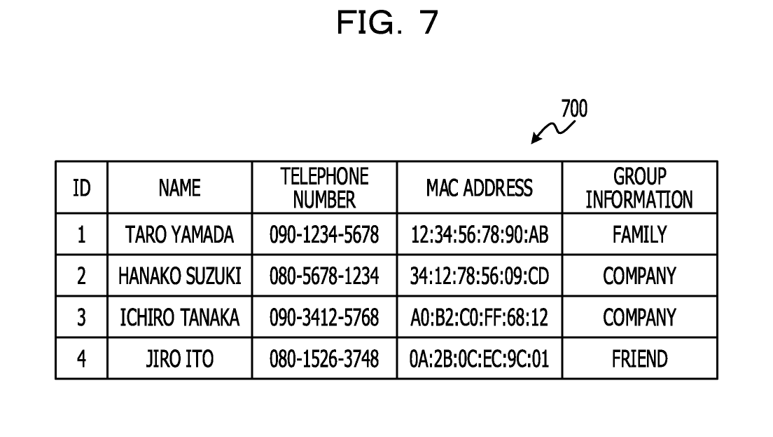

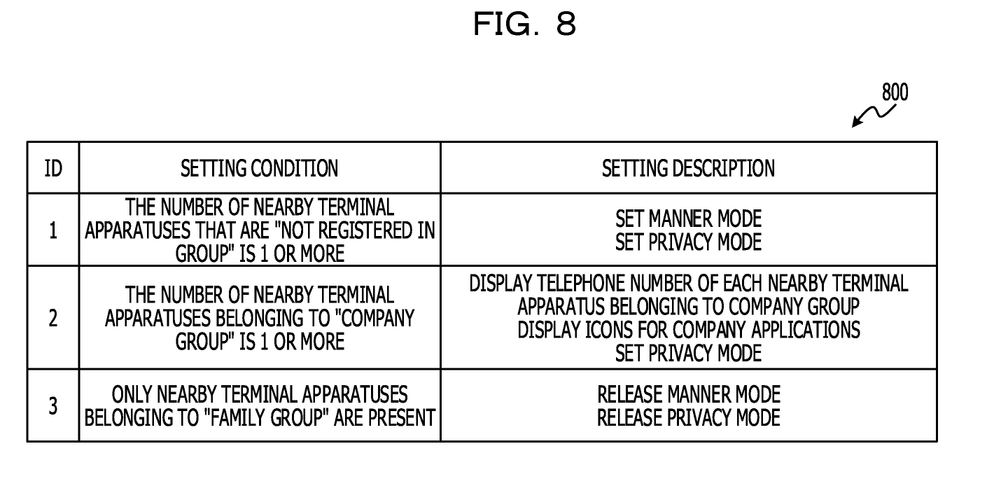

The CPU 131 is a computational processing device that executes a program for realizing the terminal apparatus 100 according to the present embodiment and a desired application. The RAM 132 is a volatile storage device that temporarily stores therein part or all of a program and data executed by the CPU 131. Examples of the program and data include telephone directories 300 and 700 described later and illustrated in FIGS. 3 and 7 and a setting condition table 800 described later and illustrated in FIG. 8. The flash memory 133 is a nonvolatile storage device that stores therein a program and data executed by the CPU 131. Examples of the program and data include the telephone directories 300 and 700 described later and illustrated in FIGS. 3 and 7 and the setting condition table 800 described later and illustrated in FIG. 8.

The near-distance wireless communication unit 140 is a communication device that performs, in accordance with a predetermined standard, wireless communication with another terminal apparatus (hereinafter referred to as a “nearby terminal apparatus”) that is located at a near distance to the terminal apparatus 100. The predetermined standard may be, for example, the Bluetooth (registered trademark) standard. The term “near distance” refers to, for example, a distance at which communication based on Bluetooth is possible. The near-distance wireless communication unit 140 includes a storage device (not illustrated) in which identification information for identifying the terminal apparatus 100 during wireless communication is stored. One example of the identification information is a Media Access Control (MAC) address, which is used in the present embodiment. In accordance with an instruction from the application unit 130, the near-distance wireless communication unit 140 periodically or irregularly performs wireless communication with a nearby terminal apparatus to exchange MAC addresses.

The vibrator 150 is a vibrating device for notifying a user of an incoming call and so on through vibration. The vibrator 150 vibrates or stops vibrating in accordance with an instruction from the application unit 130. The speaker 160 reproduces a ringtone or the like in accordance with an instruction from the application unit 130.

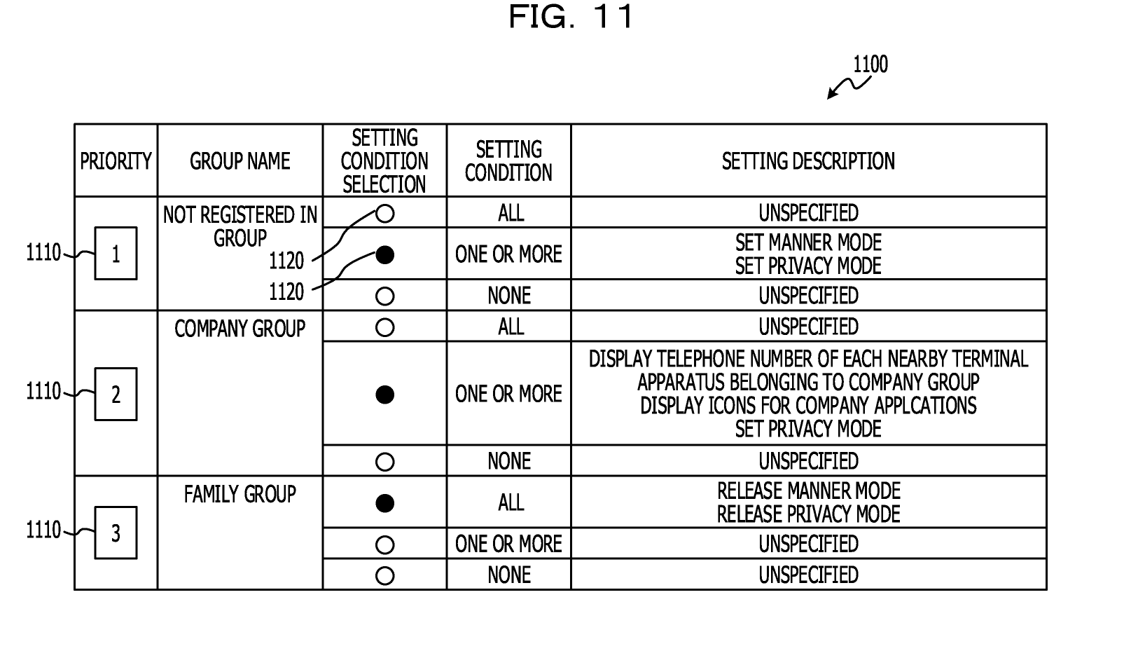

The touch panel display 170 is an input/output device that displays various pieces of information and a setting screen, for example, a setting screen 1100 described later and illustrated in FIG. 11, and also allows input of desired information with a touch operation or the like. For example, when the user touches and selects any setting condition displayed on the setting screen 1100, the touch panel display 170 may obtain the setting condition selected by the user. The touch panel display 170 also notifies the application unit 130 of the obtained setting condition.

Although not illustrated in FIG. 1, the terminal apparatus 100 may include devices for use in a mobile phone. Examples of the devices include a microphone for picking up voice during call and a speaker for reproducing voice of a person at another end of communication. The terminal apparatus 100 may also have a function for, for example, transmitting/receiving general electronic mail by causing the CPU 131 to execute a specific program.

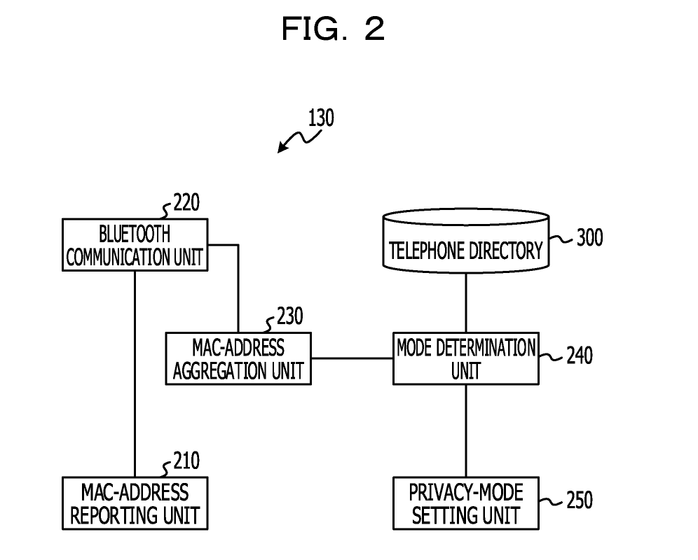

FIG. 2 is a diagram illustrating an example of a functional configuration of the application unit 130.

The application unit 130 includes a MAC-address reporting unit 210, a Bluetooth communication unit 220, a MAC-address aggregation unit 230, a mode determination unit 240, and a privacy-mode setting unit 250.

By executing a predetermined program, the CPU 131 in the application unit 130 may realize the MAC-address reporting unit 210, the Bluetooth communication unit 220, the MAC-address aggregation unit 230, the mode determination unit 240, and the privacy-mode setting unit 250.

The MAC-address reporting unit 210 periodically issues a transmission request to the Bluetooth communication unit 220 so as to report a MAC address of the terminal apparatus 100 to a nearby terminal apparatus and so as to report a MAC address of a nearby terminal apparatus. The MAC address of the terminal apparatus 100 corresponds to a MAC address stored in the storage device included in the near-distance wireless communication unit 140 in the terminal apparatus 100.

Upon receiving the transmission request from the MAC-address reporting unit 210, the Bluetooth communication unit 220 uses the near-distance wireless communication unit 140 to transmit the MAC address of the terminal apparatus 100 to the nearby terminal apparatus. Upon receiving the MAC address transmitted from the nearby terminal apparatus, the Bluetooth communication unit 220 also reports the received MAC address to the MAC-address aggregation unit 230.

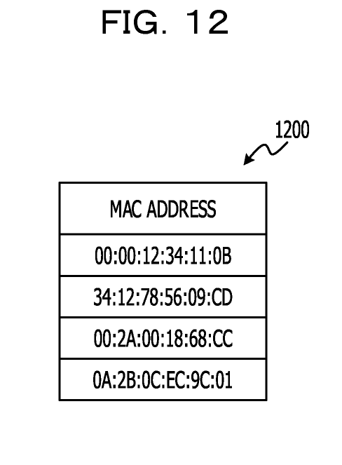

The MAC-address aggregation unit 230 creates a list (hereinafter referred to as a “MAC address list”) of MAC addresses reported from the Bluetooth communication unit 220 in a certain period of time and reports the MAC address list to the mode determination unit 240. FIG. 12 illustrates a specific example of the MAC address list.

The mode determination unit 240 refers to a telephone directory 300, stored in the flash memory 133, to identify a group to which each of the MAC addresses included in the MAC address list reported from the MAC-address aggregation unit 230 belongs. When at least one MAC address belonging to a privacy-mode group is included in the MAC address list, the mode determination unit 240 requests the privacy-mode setting unit 250 to set a privacy mode for the terminal apparatus 100.

The term “privacy mode” refers to a mode in which telephone numbers and mails from preset certain terminal apparatuses may be hidden. In the privacy mode, display on the touch panel display 170 and notification via the speaker 160 or the vibrator 150 may also be disabled, even when an incoming call or mail is received from the preset certain terminal apparatuses. In the privacy mode, icons, bookmarks, images, and so on in a main menu displayed on the touch panel display 170 may also be hidden, as appropriate.

When no MAC address belonging to the privacy-mode group is included in the MAC address list, the mode determination unit 240 requests the privacy-mode setting unit 250 to release the privacy mode set for the terminal apparatus 100.

In accordance with the request from the mode determination unit 240, the privacy-mode setting unit 250 sets the privacy mode for the terminal apparatus 100 or releases the privacy mode set for the terminal apparatus 100.

FIG. 3 is a diagram illustrating an example of the telephone directory 300 used in the present embodiment.

The telephone directory 300 includes telephone numbers (hereinafter referred to as “registered telephone numbers”) registered in the telephone directory 300, identifiers (IDs) allocated to the respective registered telephone numbers, the names of owners of the terminal apparatuses with the registered telephone numbers, MAC addresses of the terminal apparatuses with the registered telephone numbers, and information (group information) of groups to which the MAC addresses belong. For example, the user of the terminal apparatus 100 may pre-register those pieces of information in the telephone directory 300 by using the touch panel display 170 or the like.

FIG. 4 is a sequence chart illustrating an example of processing of the terminal apparatus 100. S401 to S406 illustrated in FIG. 4 correspond to S401 to S406 described below.

(S401) The Bluetooth communication unit 220 requests a nearby terminal apparatus to report a MAC address. Upon receiving the MAC address from the nearby terminal apparatus, the Bluetooth communication unit 220 reports the received MAC address to the MAC-address aggregation unit 230.

(S402) The MAC-address aggregation unit 230 temporarily stores the MAC address, which is reported from the Bluetooth communication unit 220, in a predetermined storage area in the RAM 132.

The above-described scanning of nearby terminal apparatuses (S401 and S402) may be repeatedly performed or may be performed for a certain period of time at regular intervals. The scanning of nearby terminal apparatuses (S401 and S402) may also be executed at timing when the terminal apparatus 100 receives electronic mail. The scanning of nearby terminal apparatuses (S401 and S402) may also be executed at timing of occurrence of handover, in which a base station that communicates with the terminal apparatus 100 changes, as a result of transfer of the terminal apparatus 100.

(S403) After the certain period of time passes, the MAC-address aggregation unit 230 reports, to the mode determination unit 240, the MAC address list including the MAC addresses temporarily stored in the predetermined storage area in the RAM 132 by the above-described scanning of nearby terminal apparatuses (S401 and S402) performed for the certain period of time.

(S404) The mode determination unit 240 refers to the telephone directory 300, stored in the flash memory 133, to identify a group to which each of the MAC addresses included in the MAC address list reported from the MAC-address aggregation unit 230 belongs.

(S405) When there is at least one MAC address belonging to the privacy-mode group, the mode determination unit 240 determines that a setting description to be set for the terminal apparatus 100 is the privacy mode. In this case, the mode determination unit 240 requests the privacy-mode setting unit 250 to set the privacy mode for the terminal apparatus 100. When no MAC address belonging to the privacy-mode group is included in the MAC address list, the mode determination unit 240 requests the privacy-mode setting unit 250 to release the privacy mode set for the terminal apparatus 100.

(S406) In accordance with the request by the mode determination unit 240, the privacy-mode setting unit 250 sets the privacy mode for the terminal apparatus 100 or releases the privacy mode set for the terminal apparatus 100.

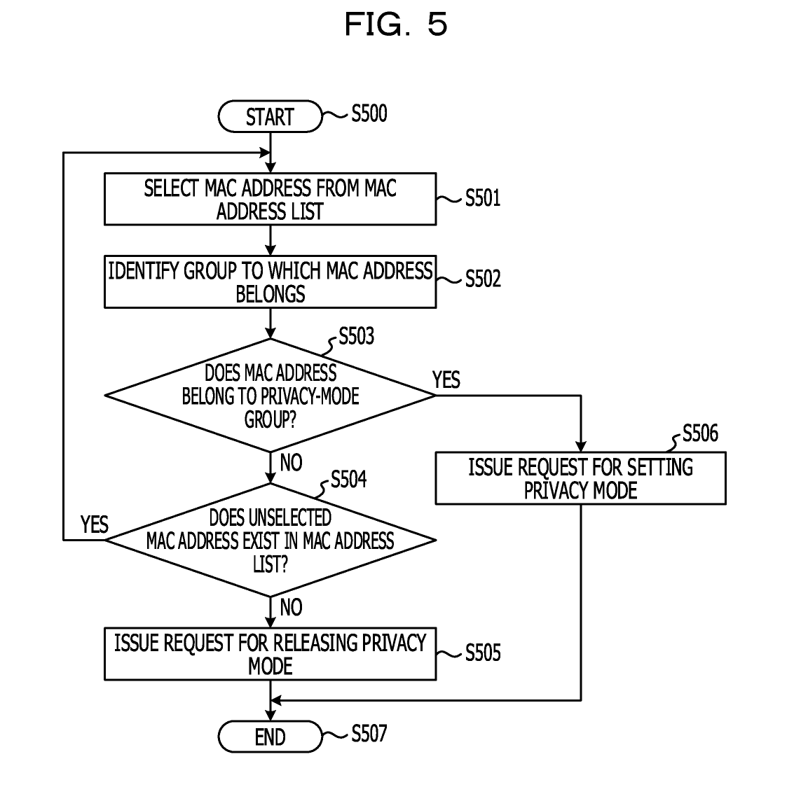

FIG. 5 is a flowchart illustrating an example of processing performed by the mode determination unit 240.

Upon receiving the MAC address list reported from the MAC-address aggregation unit 230, the mode determination unit 240 starts processing described below (in S500).

The mode determination unit 240 refers to the MAC address list to select one of the MAC addresses registered in the MAC address list (in S501).

The mode determination unit 240 refers to the telephone directory 300, stored in the flash memory 133, to identify a group to which the MAC address selected in S501 belongs (in S502).

When the MAC address selected in S501 does not belong to the privacy-mode group (NO in S503), the mode determination unit 240 checks whether or not an unselected MAC address exists in the MAC address list (in S504).

When an unselected MAC address exists in the MAC address list (YES in S504), the process of the mode determination unit 240 returns to S501. The mode determination unit 240 then selects one of the unselected MAC addresses from the MAC address list (in S501) and performs the processing in S502 to S504 again.

When no unselected MAC address exists in the MAC address list (NO in S504), the process proceeds to S505 in which the mode determination unit 240 requests the privacy-mode setting unit 250 to release the privacy mode set for the terminal apparatus 100.

When the MAC address selected in S501 belongs to the privacy-mode group (YES in S503), the process of the mode determination unit 240 proceeds to S506. In S506, the mode determination unit 240 requests the privacy-mode setting unit 250 to set the privacy mode for the terminal apparatus 100.

Upon completion of the above-described processing, the mode determination unit 240 ends the processing (in S507).

### Second Embodiment

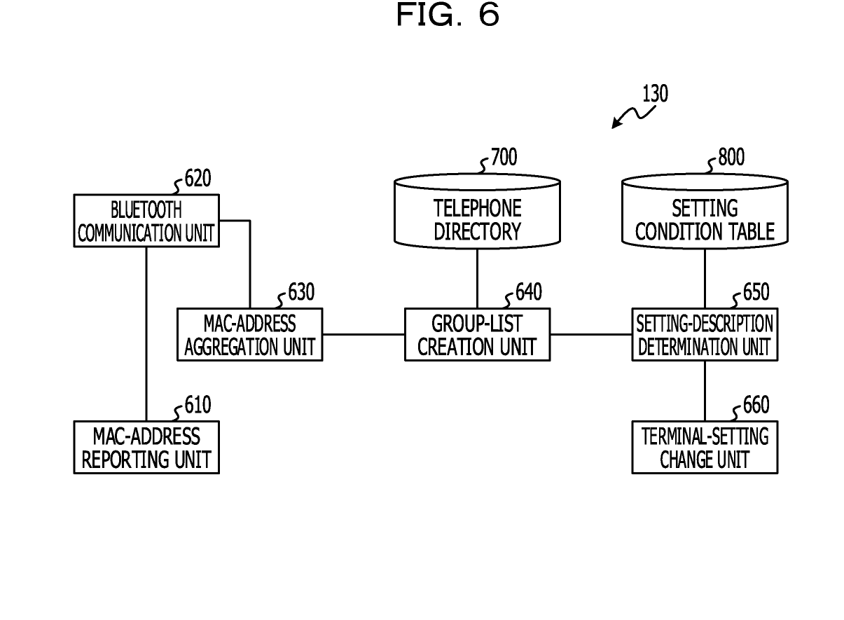

A terminal apparatus according to a second embodiment may employ the hardware configuration described above and illustrated in FIG. 1. The terminal apparatus may be a mobile phone. FIG. 6 is a diagram illustrating an example of a functional configuration of the application unit 130 that realizes a terminal apparatus 600 according to the second embodiment.

The application unit 130 that realizes the terminal apparatus 600 includes a MAC-address reporting unit 610, a Bluetooth communication unit 620, a MAC-address aggregation unit 630, a group-list creation unit 640, a setting-description determination unit 650, and a terminal-setting change unit 660.

By executing a predetermined program, the CPU 131 in the application unit 130 may realize the MAC-address reporting unit 610, the Bluetooth communication unit 620, the MAC-address aggregation unit 630, the group-list creation unit 640, the setting-description determination unit 650, and the terminal-setting change unit 660.

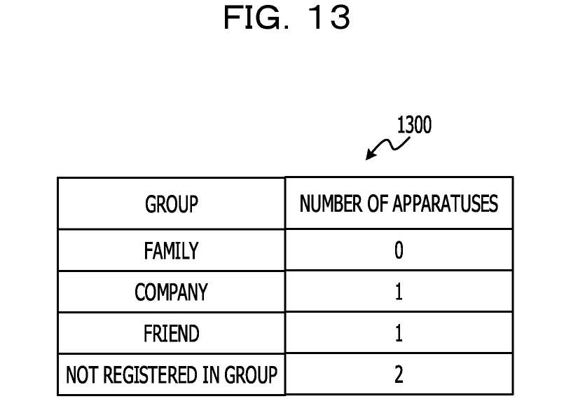

The group-list creation unit 640 refers to a telephone directory 700, stored in the flash memory 133, to identify a group to which each of MAC addresses included in a MAC address list reported from the MAC-address aggregation unit 630 belongs. The group-list creation unit 640 creates a group list including an aggregated number of nearby terminal apparatuses identified with the MAC addresses belonging to each group and reports the created group list to the setting-description determination unit 650. FIG. 13 illustrates a specific example of the group list.

The setting-description determination unit 650 refers to the setting condition table 800, stored in the flash memory 133, to determine a setting description corresponding to the group list reported from the group-list creation unit 640. The setting-description determination unit 650 then requests the terminal-setting change unit 660 to change the setting of the terminal apparatus 600 to the determined setting description.

In accordance with the setting description reported from the setting-description determination unit 650, the terminal-setting change unit 660 changes the setting of the terminal apparatus 600.

Since operations of the MAC-address reporting unit 610, the Bluetooth communication unit 620, and the MAC-address aggregation unit 630 are the same as or similar to the operations of the MAC-address reporting unit 210, the Bluetooth communication unit 220, and the MAC-address aggregation unit 230 illustrated in FIG. 2, descriptions thereof are omitted hereinafter.

FIG. 7 is a diagram illustrating an example of the telephone directory 700 used in the present embodiment.

The telephone directory 700 may include IDs allocated to registered telephone numbers, the names of owners of terminal apparatuses with the registered telephone numbers, MAC addresses of the terminal apparatuses with the registered telephone numbers, and information (group information) of groups to which the MAC addresses belong.

The group information may be information of a group representing a specific relationship, for example, a social relationship, between the user of the nearby terminal apparatus and the user of the terminal apparatus 600. Examples of the group representing the social relationship may include a company group relevant to a company, a friend group relevant to friends, and a family group relevant to a family. In the example in FIG. 7, MAC addresses “34:12:78:56:09:CD” and “A0:B2:C0:FF:68:12” belong to the company group. MAC address “0A:2B:0C:EC:9C:01” belongs to the friend group. Also, MAC address “12:34:56:78:90:AB” belongs to the family group.

FIG. 8 is a diagram illustrating an example of the setting condition table 800 used in the present embodiment.

The setting condition table 800 may include IDs allocated to respective setting conditions, the setting conditions, and setting descriptions corresponding to the setting conditions.

The setting condition exemplified at ID “1” in FIG. 8 corresponds to a case in which, in the group list, the number of nearby terminal apparatuses identified with the MAC addresses not belonging to any group (that is, “NOT REGISTERED IN GROUP” is one or more. The setting description for a case in which this setting condition is true includes “SET MANNER MODE” and “SET PRIVACY MODE” for the terminal apparatus 600. Nearby terminal apparatuses identified with MAC addresses belonging to a specific group are simply referred to as “nearby terminal apparatuses belonging to a specific group” hereinafter.

The “manner mode” refers to a mode in which, for example, ringtone reproduction by the speaker 160 is stopped and vibration by the vibrator 150 is used to give a notification for an incoming call or mail. The terminal apparatus 600 allows the user to specify a function for the terminal apparatus 600 via the touch panel display 170 in advance so as to add or remove the function to or from operations in the manner mode.

The setting condition exemplified at ID “2” corresponds to a case in which, in the group list, the number of nearby terminal apparatuses belonging to the “COMPANY GROUP” is one or more. The setting description for a case in which this setting condition is true includes “DISPLAY TELEPHONE NUMBER OF EACH NEARBY TERMINAL APPARATUS BELONGING TO COMPANY GROUP”, “DISPLAY ICONS FOR COMPANY APPLICATIONS”, and “SET PRIVACY MODE”. The company applications are applications pre-associated with the company group. The telephone numbers of the nearby terminal apparatuses belonging to the company group may include information associated with the telephone numbers of the nearby terminal apparatuses belonging to the company group. Examples of the information include the name, address, and mail address of each nearby terminal apparatus. Displaying the icons means that execution of the applications associated with the icons is enabled.

The setting condition exemplified at ID “3” corresponds to a case in which, in the group list, only nearby terminal apparatuses belonging to the “FAMILY GROUP” are present. The setting description for a case in which this setting condition is true includes “RELEASE MANNER MODE” and “RELEASE PRIVACY MODE”.

In the present embodiment, the IDs also serve to indicate priorities. In the present embodiment, the smaller the ID is, the higher the priority is. Thus, in the example in FIG. 8, when the setting condition for ID “1” is true, the setting description for ID “1” is used with high priority. For example, the ID may also be set as a priority described later and illustrated in FIG. 11.

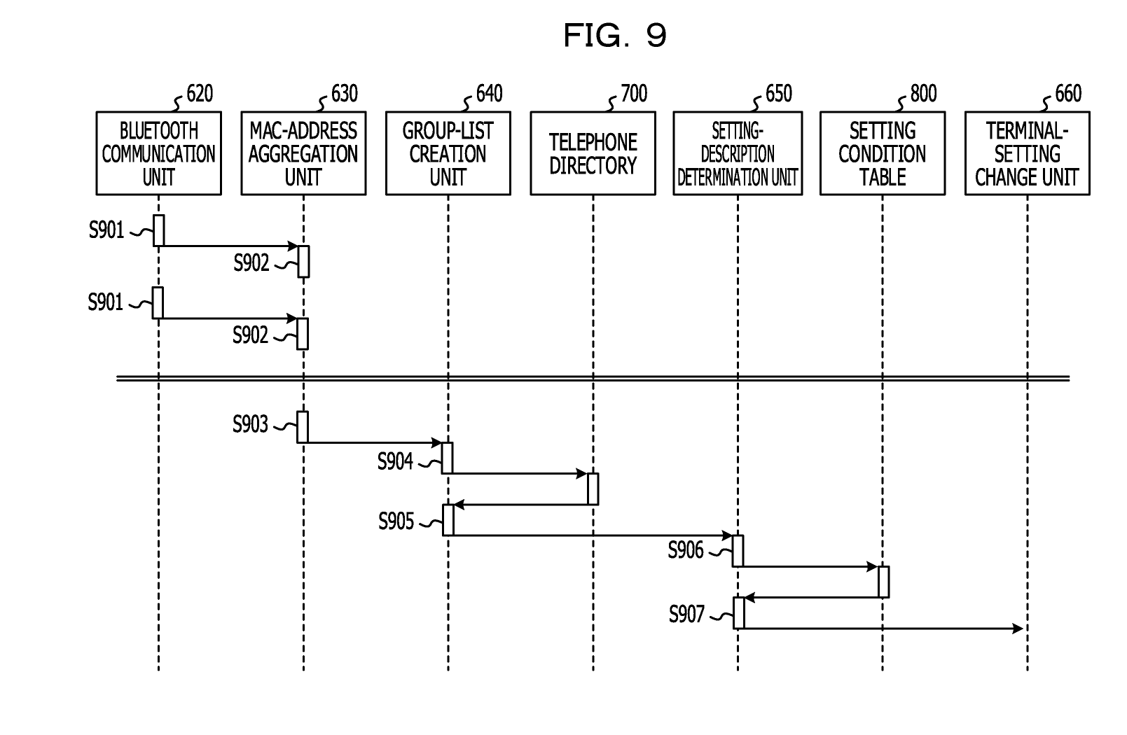

FIG. 9 is a sequence chart illustrating an example of processing performed by the terminal apparatus 600. S901 to S907 illustrated in FIG. 9 correspond to S901 to S907 described below.

(S901) The Bluetooth communication unit 620 requests a nearby terminal apparatus to report a MAC address. Upon receiving the MAC address from the nearby terminal apparatus, the Bluetooth communication unit 620 reports the received MAC address to the MAC-address aggregation unit 630.

(S902) The MAC-address aggregation unit 630 temporarily stores the MAC address, which is reported from the Bluetooth communication unit 620, in a predetermined storage area in the RAM 132.

The above-described scanning of nearby terminal apparatuses (S901 and S902) may be repeatedly performed or may be performed for a certain period of time at regular intervals. The scanning of nearby terminal apparatuses (S901 and S902) may also be executed at timing when the terminal apparatus 600 receives electronic mail. The scanning of nearby terminal apparatuses (S901 and S902) may also be executed at timing of occurrence of handover, in which a base station that communicates with the terminal apparatus 600 changes, as a result of transfer of the terminal apparatus 600.

(S903) After the certain period of time passes, the MAC-address aggregation unit 630 reports, to the group-list creation unit 640, the MAC address list including MAC addresses temporarily stored in the predetermined storage area in the RAM 132 by the above-described scanning of nearby terminal apparatuses (S901 and S902) performed for the certain period of time.

(S904) The group-list creation unit 640 refers to the telephone directory 700, stored in the flash memory 133, to identify a group to which each of the MAC addresses included in the MAC address list reported from the MAC-address aggregation unit 630 belongs.

(S905) The group-list creation unit 640 creates a group list including an aggregated number of nearby terminal apparatuses belonging to each group and reports the created group list to the setting-description determination unit 650.

(S906) Upon receiving the group list reported from the group-list creation unit 640, the setting-description determination unit 650 refers to the setting condition table 800, stored in the flash memory 133, to determine a setting description corresponding to the setting condition satisfied by the group list.

(S907) The setting-description determination unit 650 reports the determined setting description to the terminal-setting change unit 660 and requests the terminal-setting change unit 660 to change the setting of the terminal apparatus 600 in accordance with the reported setting description.

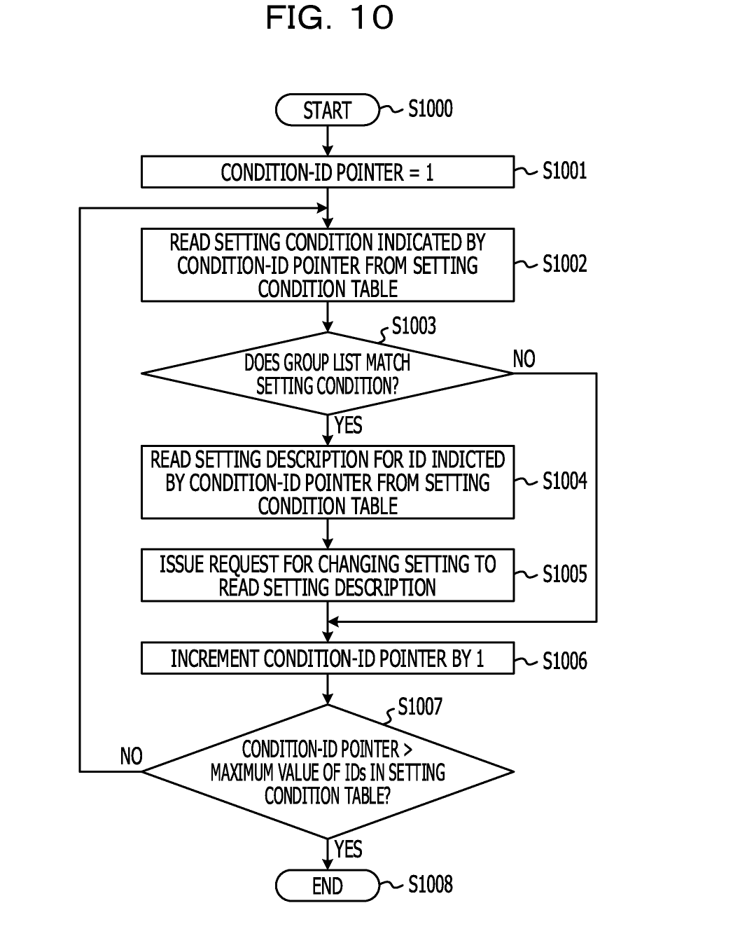

FIG. 10 is a flowchart illustrating an example of processing performed by the setting-description determination unit 650.

Upon receiving the group list from the group-list creation unit 640, the setting-description determination unit 650 starts processing described below (in S1000).

The setting-description determination unit 650 sets 1 to a variable of a condition-ID pointer (in S1001).

The setting-description determination unit 650 refers to the setting condition table 800, stored in the flash memory 133, to read the setting condition for the ID indicated by the condition-ID pointer (in S1002).

When the group list matches the setting condition read in S1002 (YES in S1003), the process of the setting-description determination unit 650 proceeds to S1004. In this case, the setting-description determination unit 650 refers to the setting condition table 800 to read the setting description for the ID indicated by the condition-ID pointer (in S1004). The setting-description determination unit 650 then requests the terminal-setting change unit 660 to change the setting of the terminal apparatus 600 in accordance with the setting description read in S1004 (in S1005). Thereafter, the process of the setting-description determination unit 650 proceeds to S1006.

When the determination in S1003 indicates that the group list does not match the setting condition read in S1002 (NO in S1003), the process of the setting-description determination unit 650 proceeds to S1006.

In S1006, the setting-description determination unit 650 increments the value of the condition-ID pointer by 1.

When the value of the condition-ID pointer is smaller than or equal to the maximum value of the IDs included in the setting condition table 800 (NO in S1007), the process of the setting-description determination unit 650 returns to S1002. The setting-description determination unit 650 then repeats the processing in S1002 to S1007.

When the value of the condition-ID pointer is larger than the maximum value of the IDs included in the setting condition table 800 (YES in S1007), the process of the setting-description determination unit 650 proceeds to S1008. The setting-description determination unit 650 then ends the processing (in S1008).

FIG. 11 is a diagram illustrating an example of the setting screen 1100 for the setting condition table 800.

The setting screen 1100 includes “priority input” fields, “group name display” fields, “setting condition selection” fields, “setting condition display” fields, and “setting description display” fields.

The “priority input” fields include fields 1110 to which the user inputs priorities for the respective setting conditions. The priorities input to the “priority input” fields may be used as the IDs in the setting condition table 800 illustrated in FIG. 8.

The “group name display” fields display, for example, the names of groups registered in the telephone directory 700.

The “setting condition selection” fields display radio buttons 1120 for selection of the setting conditions. Unselected radio buttons 1120 are indicated by “◯” and selected radio buttons 1120 are indicated by “”. In FIG. 11, as an example, a case in which “ONE OR MORE” is illustrated as a setting condition for “NOT REGISTERED IN GROUP”.

The “setting condition display” fields display setting conditions associated with the groups displayed in the “group name display” fields. For example, “ALL” indicated as the setting condition for “NOT REGISTERED IN GROUP” in FIG. 11 corresponds to a case in which no nearby terminal apparatus belongs to any of the groups indicated in the group information in the telephone directory 700. Also, “ONE OR MORE” corresponds to a case in which the number of nearby terminal apparatuses not belonging to any of the groups indicated in the group information in the telephone directory 700 is one or more. Also, “NONE” corresponds to a case in which the number of nearby terminal apparatuses not belonging to any of the groups indicated in the group information in the telephone directory 700 is zero.

The “setting description display” fields display setting descriptions when the setting conditions displayed in the corresponding “setting condition display” fields are satisfied. For example, in FIG. 11, “SET MANNER MODE” and “SET PRIVACY MODE” are displayed in the “setting description display” field when the setting condition “ONE OR MORE” for “NOT REGISTERED IN GROUP” is satisfied. “UNSPECIFIED” set in the “setting description display” field indicates that there are no setting changes to be made on the terminal apparatus 600.

The group names, the setting conditions, and the setting descriptions illustrated in FIG. 11 are merely exemplary and are not intended to limit the contents of the setting condition table 800. Although FIG. 11 illustrates an example of a case in which predetermined setting conditions and setting descriptions are displayed on the setting screen 1100, the setting conditions and the setting descriptions may be displayed so as to allow the user to select a setting condition and a setting description from multiple items.

FIG. 12 is a diagram illustrating an example of a MAC address list. A MAC address list 1200 includes MAC addresses that the MAC-address aggregation unit 230 or the MAC-address aggregation unit 630 has received from nearby terminal apparatuses in a certain period of time.

FIG. 13 is a diagram illustrating an example of a group list. A group list 1300 includes information indicating the number of nearby terminal apparatuses belonging to each group. In the example in FIG. 13, the number of nearby terminal apparatuses belonging to the family group is 0 as an example. Also, the number of nearby terminal apparatuses not belonging to any of the groups indicated in the telephone directory 700 (that is, “NOT REGISTERED IN GROUP”) is 2.

Setting descriptions corresponding to various setting conditions may also be used other than the setting conditions and setting descriptions illustrated in the setting condition table 800. Examples will be described below.

Setting of Manner Mode

With respect to a setting condition, for example, when the number of nearby terminal apparatuses is a certain number or more or when any nearby terminal apparatus belongs to the company group is present, a setting description for setting the manner mode may be added to the setting condition table 800. In this case, when there are many people in the vicinity of the user or when there are colleagues in the vicinity of the user, the mode of the terminal apparatus 600 may be automatically switched to the manner mode.

Setting of Terminal Operation Lock

For example, with respect to a setting condition for a case in which only nearby terminal apparatuses that are not registered in any group are present, a setting description for enabling an operation lock function for restricting the operation of the terminal apparatus 600 may be added to the setting condition table 800. For example, with respect to a setting condition for a case in which only nearby terminal apparatuses belonging to the family group are present, a setting description for disabling the operation lock function for the terminal apparatus 600 may also be added to the setting condition table 800. In this case, the operation lock function for the terminal apparatus 600 is automatically enabled under a situation in which there are no acquaintances in the vicinity of the user. Thus, it is possible to ensure a certain degree of security, even if the user misplaces the terminal apparatus 600 somewhere.

Restriction of Terminal Operation

For example, a setting condition for a case in which any nearby terminal apparatus belonging to the company group is present and, for example, current position of the terminal apparatus 600, acquired by a GPS or the like, is within a certain range from a pre-registered company location may be added to the setting condition table 800. With respect to the setting condition, for example, a setting description for restricting reference to predetermined data, files, content, contact information, and so on stored on the terminal apparatus 600 or for changing a range to which reference may be made may also be added to the setting condition table 800. In addition, for example, a setting description for restricting execution of a specific application may be added to the setting condition table 800.

Setting of Devices

With respect to a setting condition for a case in which a certain or more number of nearby terminal apparatuses not registered in any group are present, a setting description for reducing the brightness of the touch panel display 170 to a predetermined numeric value may be added to the setting condition table 800. In this case, a setting description for connection with a Bluetooth headset may be added to the setting condition table 800. It may be determined that a place where the number of nearby terminal apparatuses that are not registered in any group is a certain number or more is a public place. Thus, in a public place, by reducing the brightness of the touch panel display 170 of the terminal apparatus 600, it is possible to significantly reduce the possibility of peeking from the side.

Setting of Time Slot

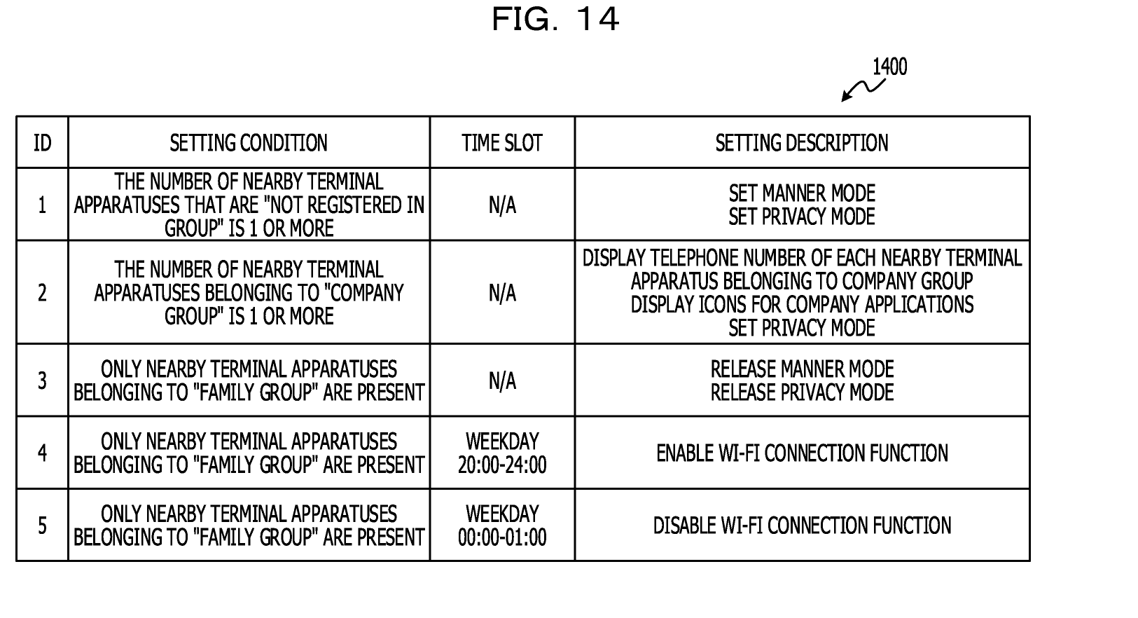

Time slots may be added to the setting conditions in the setting condition table 800. FIG. 14 illustrates an example of a case in which time slots are added to the setting condition table 800. A setting condition table 1400 is a table obtained by adding “time slot” fields to the setting condition table 800 illustrated in FIG. 8. Time slots set in the “time slot” fields are conditions that further restrict the setting conditions.

For example, “WEEKDAY 20:00-24:00” is set in the “time slot” field for ID “4” in the setting condition table 1400. FIG. 14 illustrates that, in this case, a setting condition for enabling a Wireless Fidelity (Wi-Fi) connection function for the terminal apparatus 600 when only nearby terminal apparatuses belonging to the family group are present and the current time is in the time slot of 20:00 to 24:00 on weekdays.

Setting of Power-Saving Mode

For example, with respect to a setting condition for a case in which a certain or more number of nearby terminal apparatuses not registered in any group are present, a setting description for reducing the clock rate of the CPU 131 in the terminal apparatus 600 to a predetermined numeric value may be added to the setting condition table 800. For example, with respect to a setting condition for a case in which a certain or more number of nearby terminal apparatuses not registered in any group are present, a setting description for reducing the frequency of scanning the Wi-Fi connection to a certain frequency may be added to the setting condition table 800.

When the terminal apparatus 600 is placed in a place where a certain or more number of nearby terminal apparatuses not registered in any group are present, it may be determined that the user of the terminal apparatus 600 is away from home or office. Thus, while the user is away from home or office, it is possible to reduce the clock rate of the CPU 131 or it is possible to reduce the power consumption of the terminal apparatus 600 by reducing the frequency of scanning the Wi-Fi connection.

Switching of Telephone Number

When the terminal apparatus 600 is a terminal apparatus that allows for use of multiple telephone numbers, such as a main number and a sub number, for example, a setting description for switching the telephone number of the company to the main number with respect to a setting condition for a case in which any nearby terminal apparatus belonging to the company group is present may be added to the setting condition table 800.

Setting of Display Screen

For example, with respect to a setting condition for a case in which any nearby terminal apparatus belonging to the family group is present, a setting description for switching image data to be displayed on a standby screen on the terminal apparatus 600 to predetermined image data, such as image data of a family picture, may be added to the setting condition table 800.

The MAC addresses are an example of identification information. The privacy-mode group illustrated in FIG. 3, the family group, the company group, and the friend group illustrated in FIG. 7 and so on are examples of groups to which nearby terminal apparatuses belong. The telephone directory 700 illustrated in FIG. 7 is an example of group information in which information regarding groups to which the nearby terminal apparatuses belong is pre-stored for respective pieces of identification information of the nearby terminal apparatuses.

As described above, the terminal apparatus 100 creates a MAC address list including MAC addresses received from one or more nearby terminal apparatuses in a certain period of time. On the basis of the telephone directory 300, the terminal apparatus 100 identifies the group to which each of the MAC addresses included in the MAC address list belongs. When at least one nearby terminal apparatus belonging to the privacy-mode group is present, the terminal apparatus 100 changes the setting of the terminal apparatus 100 to the privacy mode.

The terminal apparatus 600 creates a MAC address list including MAC addresses received from one or more nearby terminal apparatuses in a certain period of time. On the basis of the telephone directory 700, the terminal apparatus 600 identifies the group to which each of the MAC addresses included in the MAC address list belongs and creates a group list. On the basis of the setting condition table 800, the terminal apparatus 600 determines a setting description corresponding to the setting condition satisfied by the group list, and changes the setting of the terminal apparatus 600 to the determined setting description.

As described above, each of the terminal apparatuses 100 and 600 may determine a setting description on the basis of a specific condition for the group to which each nearby terminal apparatus belongs and may change the setting of each of the terminal apparatuses 100 and 600 in accordance with the determined setting description. In this case, the group to which each nearby terminal apparatus belongs may be regarded as indicating a situation in which each of the terminal apparatuses 100 and 600 is placed, for example, a situation in which a specific person is present in the vicinity of each of the terminal apparatuses 100 and 600. Hence, each of the terminal apparatuses 100 and 600 may be regarded as being able to switch the setting of each of the terminal apparatuses 100 and 600 in accordance with a situation in which it is placed.

In addition, each of the terminal apparatuses 100 and 600 does not obtain the position information of nearby terminal apparatuses by utilizing a GPS or the like. Thus, for example, even indoors where the GPS or the like is not available, it is also possible to change the setting of each of the terminal apparatuses 100 and 600 in accordance with the situation in which each of the terminal apparatuses 100 and 600 is placed.

In addition, each of the terminal apparatuses 100 and 600 determines a setting description on the basis of a specific condition for the group to which each nearby terminal apparatus belongs. Thus, even when the user of each of the terminal apparatuses 100 and 600 takes an action that is different from his or her ordinary action, it is possible to switch the setting of each of the terminal apparatuses 100 and 600 to a setting description corresponding to the situation in which each of the terminal apparatuses 100 and 600 is placed.

For example, when the user of each of the terminal apparatuses 100 and 600 takes an annual leave on a working day to spend time with his or her family, only the nearby terminal apparatuses belonging to the family group are present in the vicinity of each of the terminal apparatuses 100 and 600. In this case, each of the terminal apparatuses 100 and 600 changes the setting to a setting description for spending time with the family, which is illustrated at ID “3” in the setting condition table 800, not the setting description for work, which is illustrated at ID “2”. Even when the user is in his or her office, if only strangers are present in the vicinity of the user, this means that only nearby terminal apparatuses not registered in any group are present in the vicinity of the user. In this case, each of the terminal apparatuses 100 and 600 switches the description of its setting to a setting description for a case in which the user is present in a public space, the setting description being illustrated at ID “1” in the setting condition table 800. When colleagues are present in the vicinity of the user, this means that nearby terminal apparatuses belonging to the company group are present. In this case, each of the terminal apparatuses 100 and 600 switches the description of its setting to the setting description for work, which is illustrated at ID “2” in the setting condition table 800. Thus, even when the user is in his or her office, it is possible to switch the setting of each of the terminal apparatuses 100 and 600 between the setting description for a case in which acquaintances are present in the vicinity of the user and the setting description for a case in which only strangers are present in the vicinity of the user.

As described above, the terminal apparatuses according to the embodiment are capable of switching the description of the setting to a desired setting description corresponding to a situation in which the terminal apparatuses are placed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A terminal apparatus comprising:
a memory to store group information in association with identification information for identifying respective nearby apparatuses within a certain range from the terminal apparatus, the group information indicating first groups to which the respective nearby apparatuses belong; and
a processor to
receive first identification information of respective first nearby apparatuses in a certain period of time,
identify, based on the group information, second groups to which the first nearby apparatuses identified by respective pieces of the received first identification information belong,
determine a setting description for the terminal apparatus in accordance with the identified second groups, and
change setting of the terminal apparatus in accordance with the determined setting description.

2. The terminal apparatus according to claim 1, wherein
users of second nearby apparatuses belonging to a third group indicated by first group information have a specific relationship with a user of the terminal apparatus.

3. The terminal apparatus according to claim 1, wherein
the processor determines the setting description based on predetermined setting descriptions, the predetermined setting descriptions being predetermined for a specific group in accordance with a number of second nearby apparatuses belonging to the specific group, the second nearby apparatuses being included in the first nearby apparatuses.

4. The terminal apparatus according to claim 1, wherein
the setting description includes at least one of
setting of a manner mode,
setting of a privacy mode,
whether information regarding nearby apparatuses belonging to a predetermined one of the first groups is to be displayed, and
whether execution of predetermined application programs is to be enabled.

5. The terminal apparatus according to claim 1, wherein
when the first nearby apparatuses include at least a predetermined number of nearby apparatuses belonging to none of the first groups, the determined setting description includes at least one of
setting of a manner mode and
setting of a privacy mode.

6. The terminal apparatus according to claim 1, wherein
when the first nearby apparatuses include at least a predetermined number of second nearby apparatuses belonging to a predetermined one of the first groups, the determined setting description includes at least one of
whether information regarding the second nearby apparatuses is to be displayed and
whether execution of application programs associated with the second nearby apparatuses is to be enabled.

7. The terminal apparatus according to claim 1, wherein
when the first nearby apparatuses include only second nearby apparatuses belonging to a predetermined one of the first groups, the determined setting description includes at least one of
release of a manner mode and
release of a privacy mode.

8. A method for changing setting of a terminal apparatus, the method comprising:
receiving, by the terminal apparatus, identification information of respective nearby apparatuses in a certain period of time, the identification information being for identifying the respective nearby apparatuses, the nearby apparatuses being within a certain range from the terminal apparatus;
identifying, based on group information, groups to which the nearby apparatuses identified by respective pieces of the received identification information belong, the group information being associated with respective pieces of the identification information, the group information indicating groups to which the respective nearby apparatuses belong;
determining a setting description for the terminal apparatus in accordance with the identified groups; and
changing setting of the terminal apparatus in accordance with the determined setting description.

9. A computer-readable recording medium storing a program that causes a computer to execute a procedure, the procedure comprising:
receiving identification information of respective nearby apparatuses in a certain period of time, the identification information being for identifying the respective nearby apparatuses, the nearby apparatuses being within a certain range from the computer;
identifying, based on group information, groups to which the nearby apparatuses indicated by respective pieces of the received identification information belong, the group information being associated with respective pieces of the identification information, the group information indicating groups to which the respective nearby apparatuses belong;
determining a setting description for the computer in accordance with the identified groups; and
changing setting of the computer in accordance with the determined setting description.
